(19) United States
(12) Patent Application Publication
(10) Pub. No.: US 2024/0377923 A1
(43) Pub. Date: Nov. 14, 2024

(54) USER INTERFACES FOR VERSION TRACKING OF DOCUMENTS

(71) Applicant: Apple Inc., Cupertino, CA (US)

(72) Inventors: Christopher D. SOLI, San Francisco, CA (US); Grant R. PAUL, San Francisco, CA (US); Jennifer P. CHEN, Mountain View, CA (US); David HERNANDEZ ALVAREZ, Sunnyvale, CA (US); Aram D. KUDURSHIAN, San Francisco, CA (US)

(21) Appl. No.: 18/658,909

(22) Filed: May 8, 2024

Related U.S. Application Data
(60) Provisional application No. 63/501,129, filed on May 9, 2023.

(51) Int. Cl. G06F 3/0482; G06F 3/0487; G06F 9/451; G06F 40/166; G06F 40/197

(52) U.S. Cl. CPC G06F 3/0482; G06F 9/451; G06F 40/166; G06F 40/197; G06F 3/0487

(57) ABSTRACT

In some embodiments, an electronic device facilitates version tracking of documents based on actions associated with the document. In some embodiments, an electronic device displays a representation of a second version of a content item in accordance with a determination that the electronic device has access to a first version and a second version of a content item.

### CROSS-REFERENCE TO RELATED APPLICATIONS

This application claims the benefit of U.S. Provisional Application No. 63/501,129, filed May 9, 2023, the contents of which are herein incorporated by reference in their entireties for all purposes.

### FIELD OF THE DISCLOSURE

This disclosure relates generally to an electronic device presenting user interfaces for version tracking of documents.

### BACKGROUND OF THE DISCLOSURE

User interaction with electronic devices has increased significantly in recent years. These devices can be devices such as computers, tablet computers, televisions, multimedia devices, or mobile devices. While presenting content using an electronic device, the user may wish to view different versions of the content. The user may therefore desire efficient ways of version tracking.

### SUMMARY OF THE DISCLOSURE

Providing efficient ways of presenting content to a user via an application of an electronic device may improve the user's experience with the electronic device and reduce the number of inputs needed to sort through and identify different versions of the same content, thereby reducing power usage and improving the battery life of the electronic device.

In some embodiments, an electronic device facilitates version tracking of documents based on actions associated with the document. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6H illustrate examples of an electronic device facilitating version tracking of documents based on actions associated with the document in accordance with some embodiments of the disclosure.

FIGS. 7A-7F illustrates a flow diagram illustrating a method in which an electronic device facilitates version tracking of documents based on actions associated with the document in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for user interfaces that can present and track various versions of content. In some embodiments, an electronic device facilitates version tracking of documents based on actions associated with the document. In some embodiments, an electronic device displays a representation of a second version of a content item in accordance with a determination that the electronic device has access to a first version and a second version of a content item. Such techniques present a latest version of a content item that the user may be interested in viewing easily accessible, thus reducing the likelihood of erroneous inputs directed towards the electronic device.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### EXEMPLARY DEVICES

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

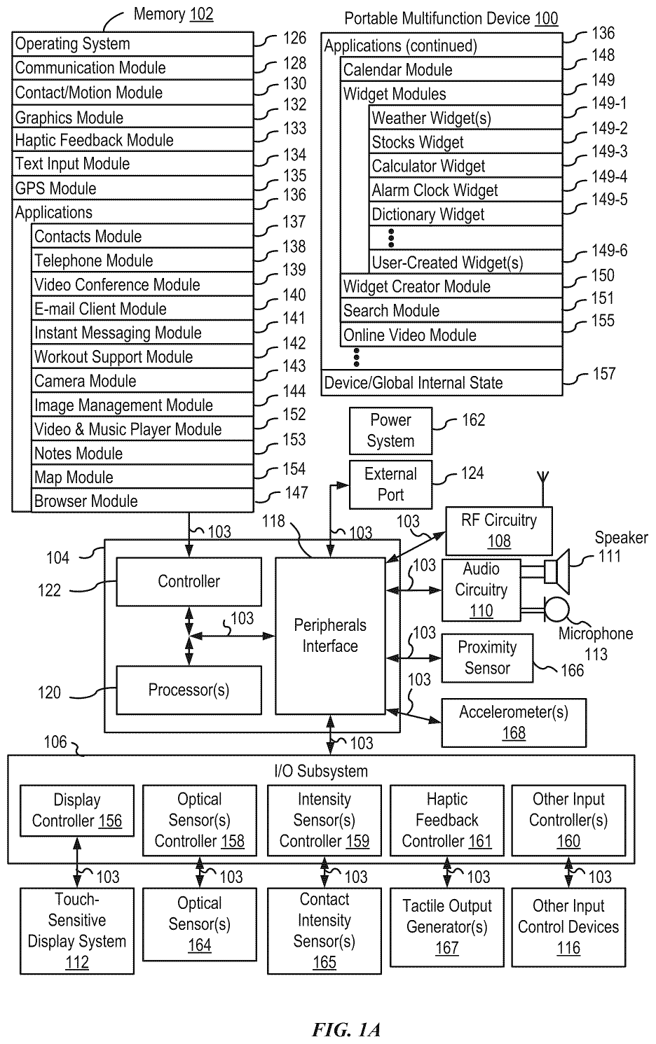

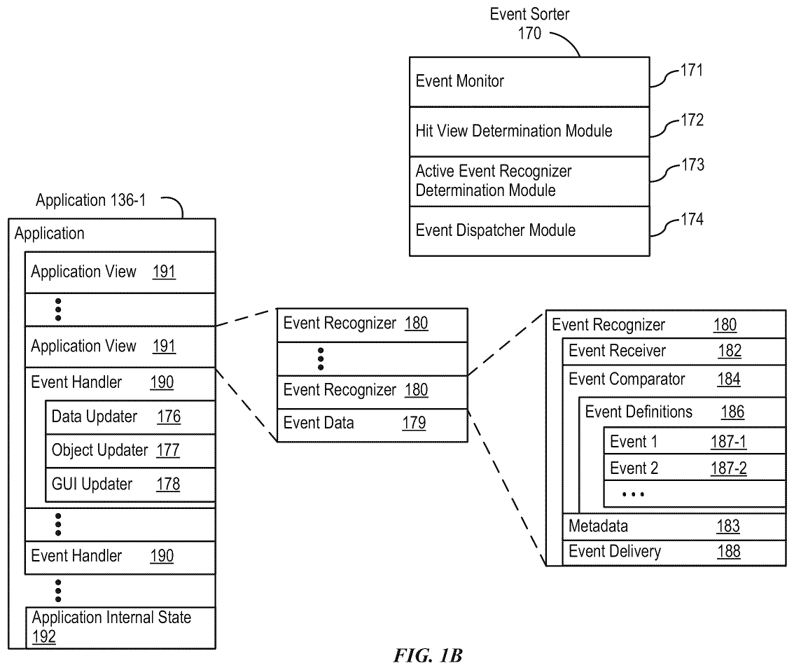

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

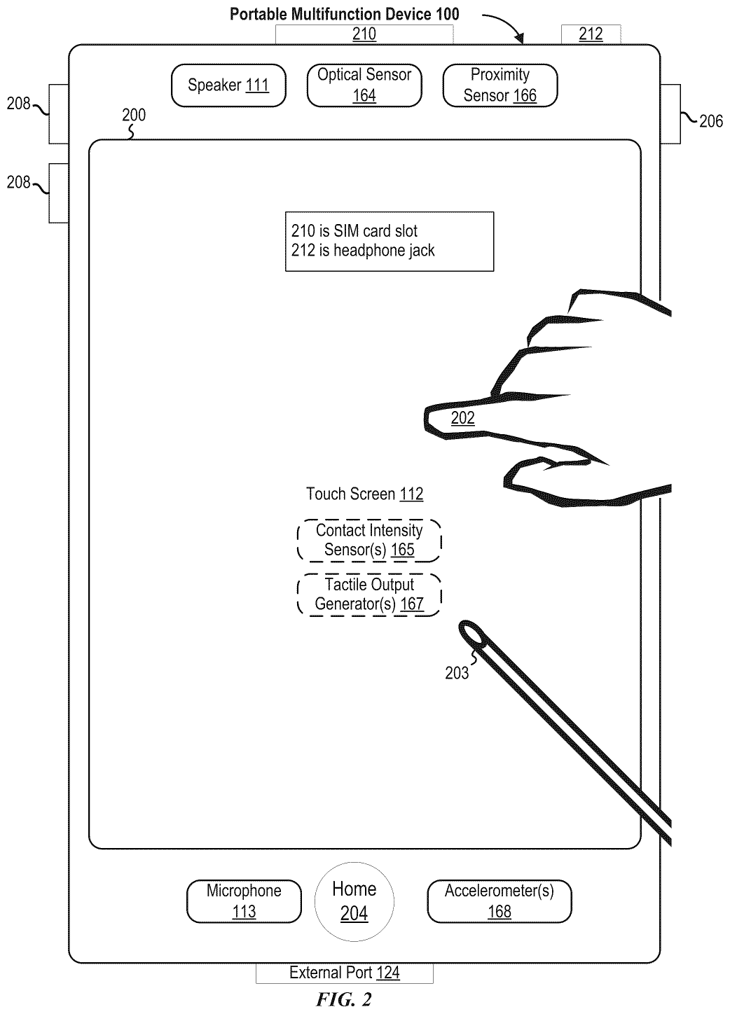

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's car (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

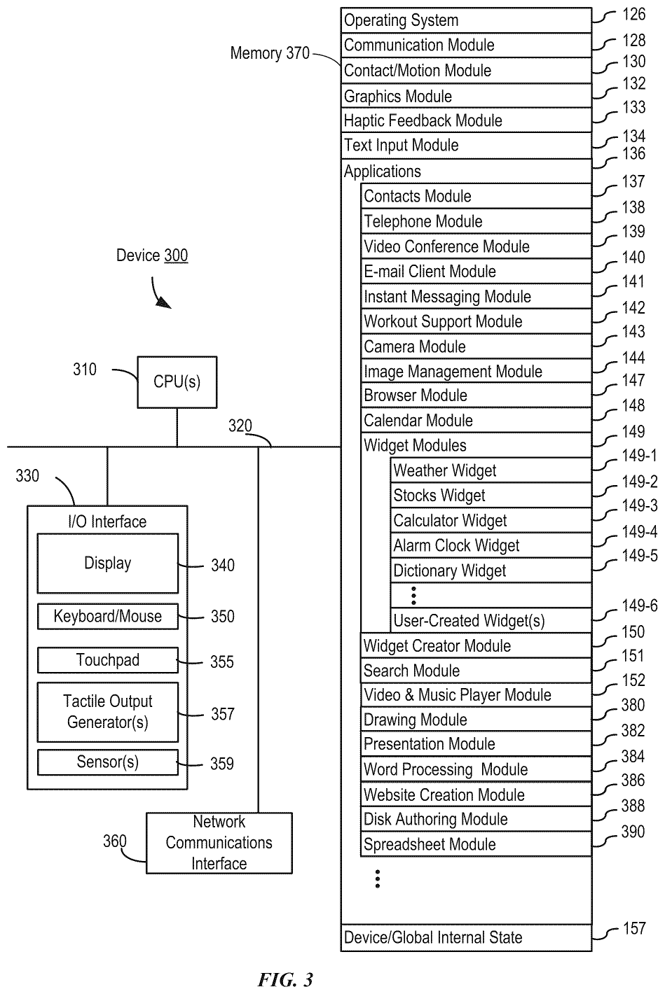

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

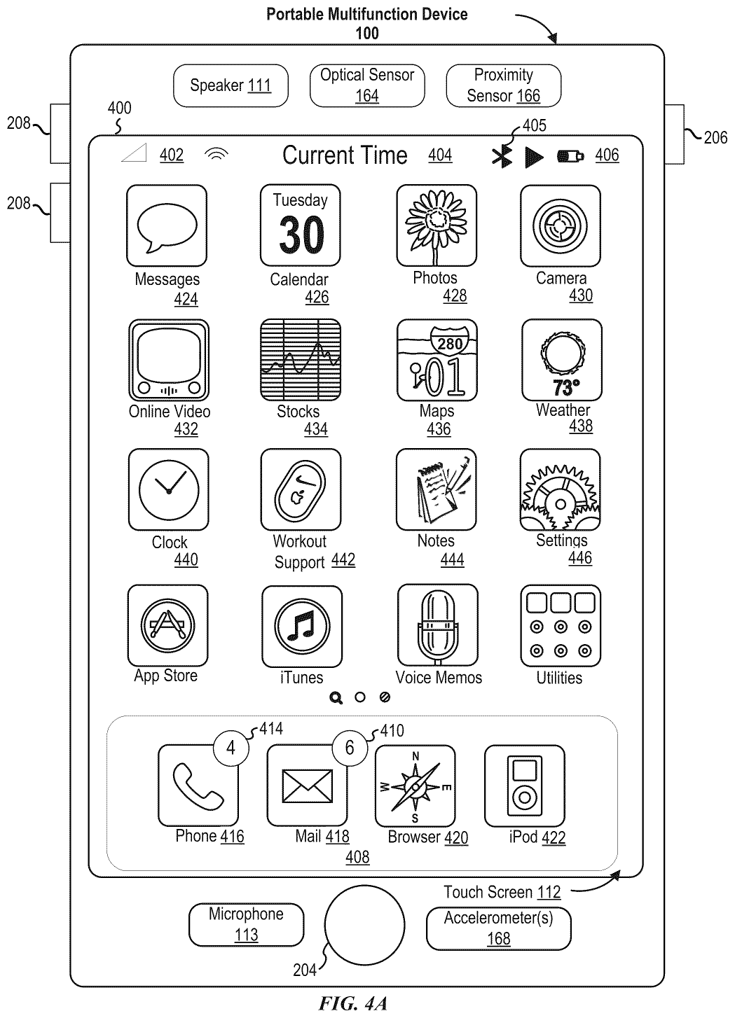

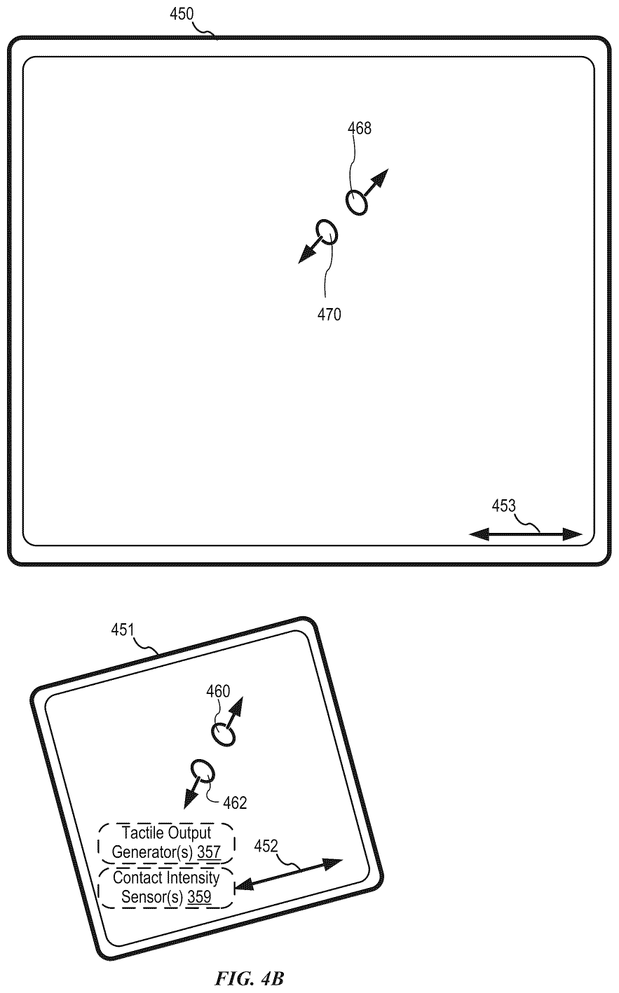

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For case of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

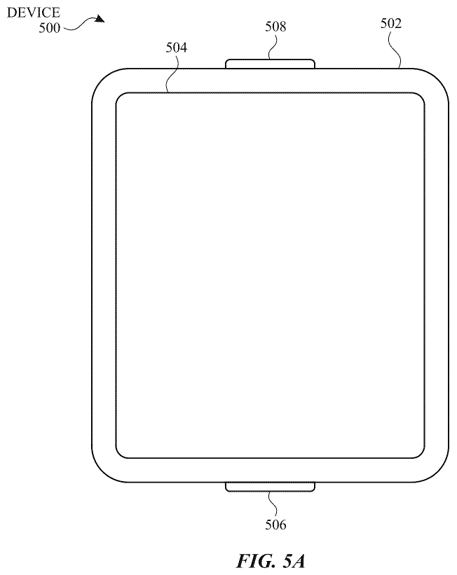

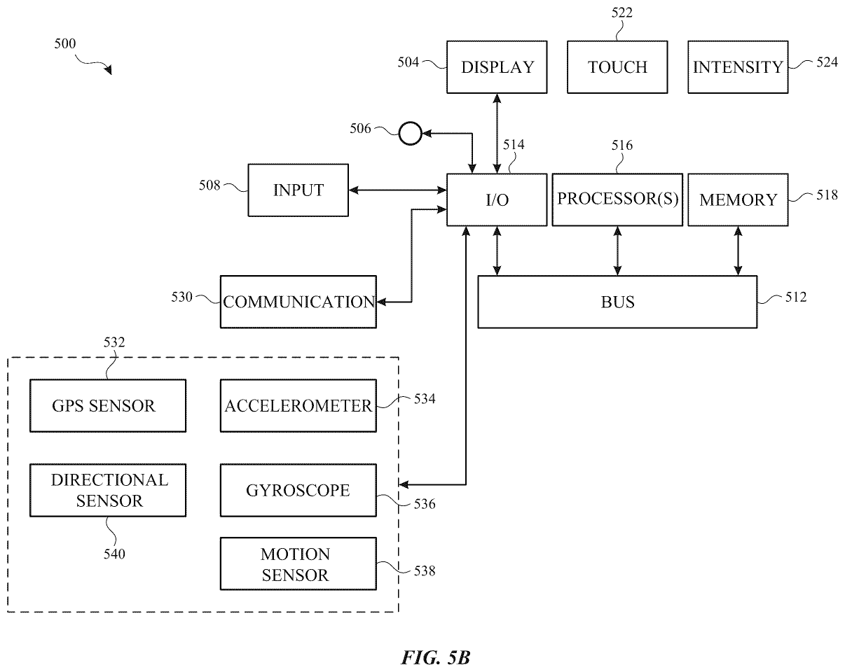

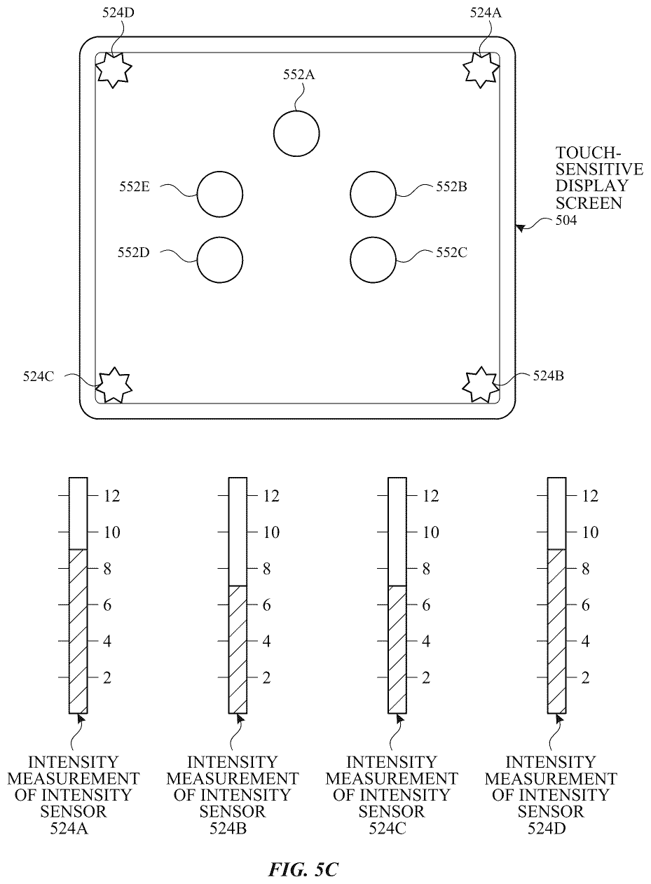

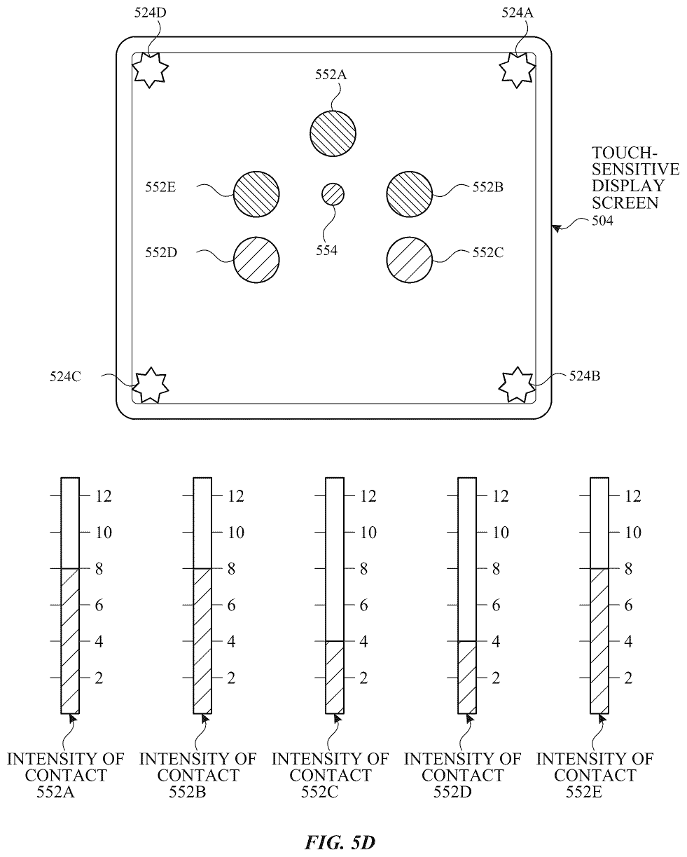

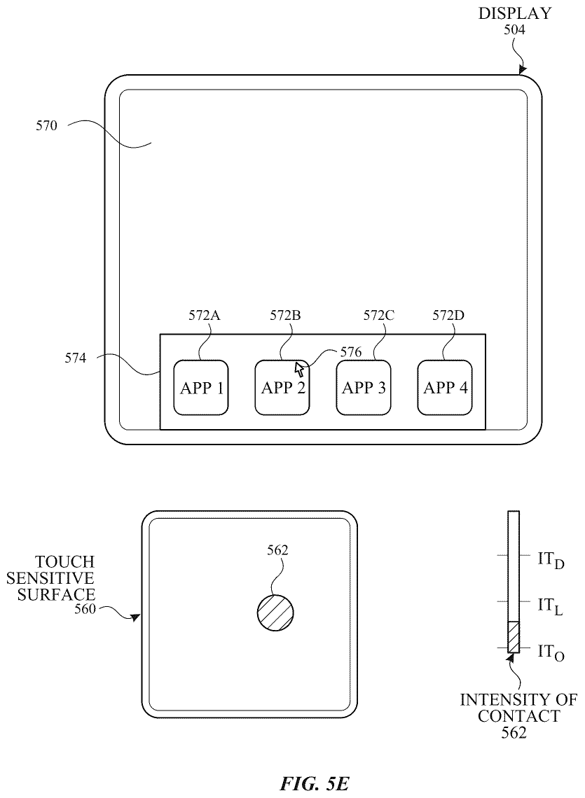

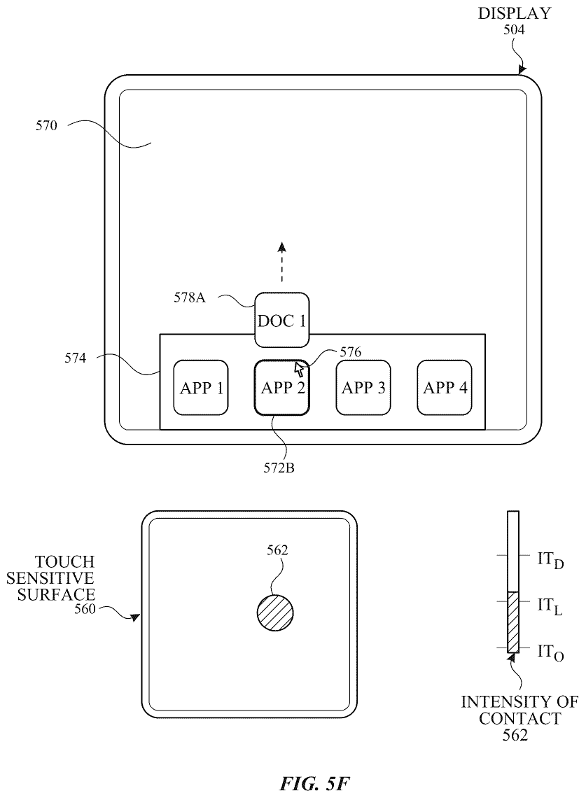

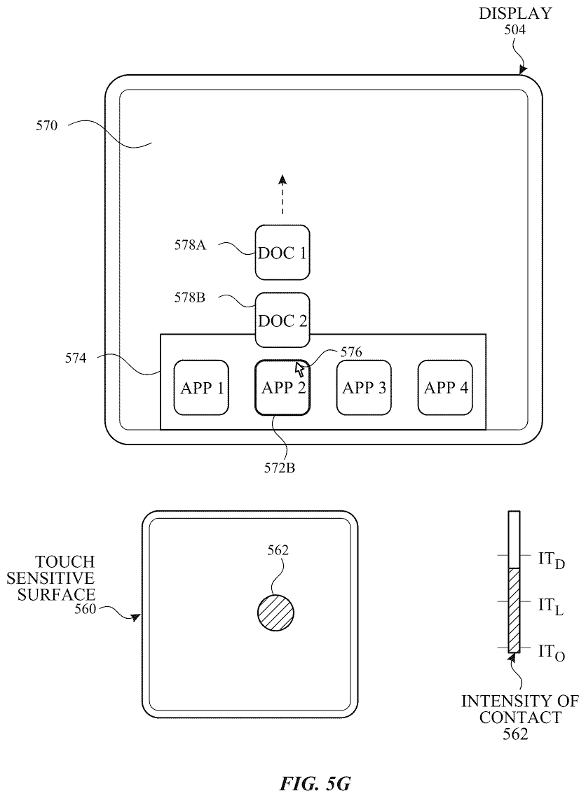

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A· (Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### Version Tracking of Documents

Users interact with electronic devices in many different manners. In some embodiments, an electronic device facilitates version tracking of documents. The embodiments described below provide ways in which an electronic device facilitates version tracking of documents in various applications. Enhancing interactions with a device by version tracking content reduces the amount of time needed by a user to perform operations, and thus reduces the power usage of the device and increases battery life for battery-powered devices. It is understood that people use devices. When a person uses a device, that person is optionally referred to as a user of the device.

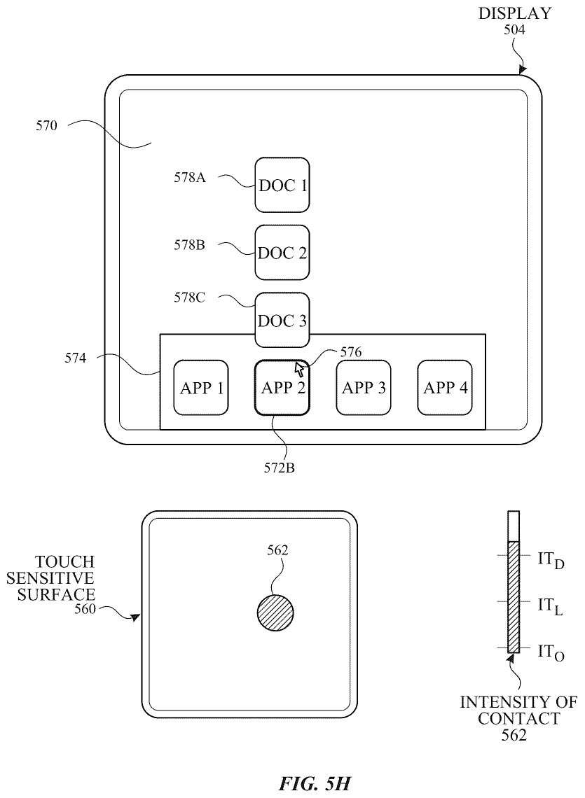

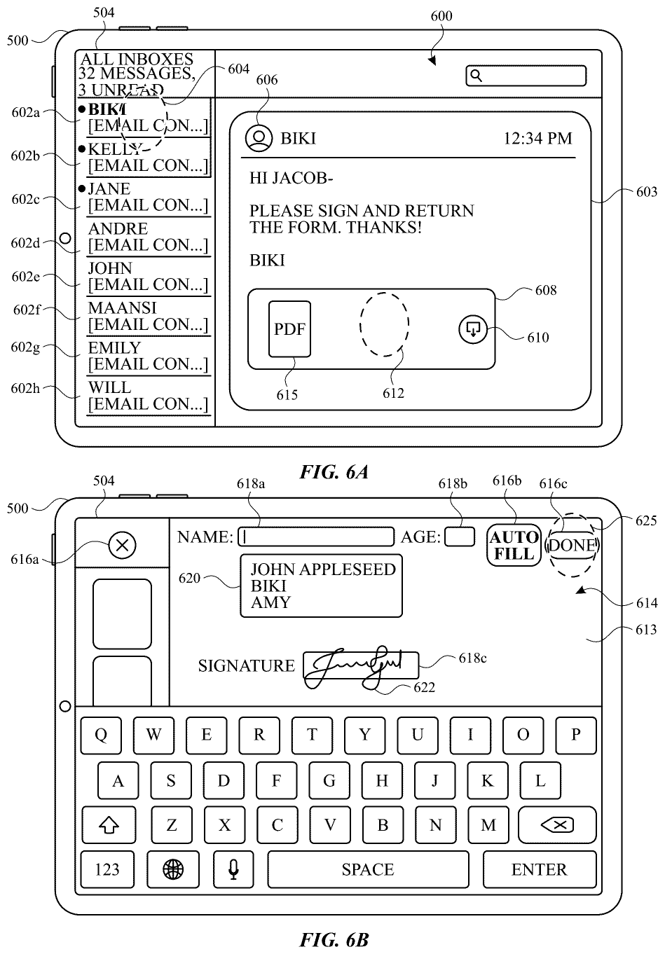

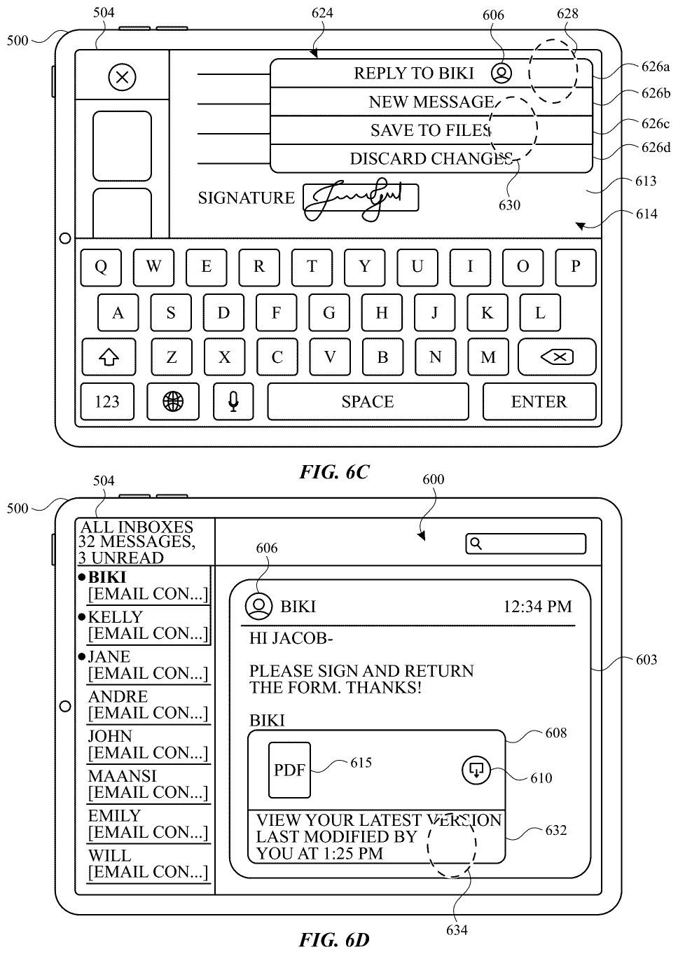

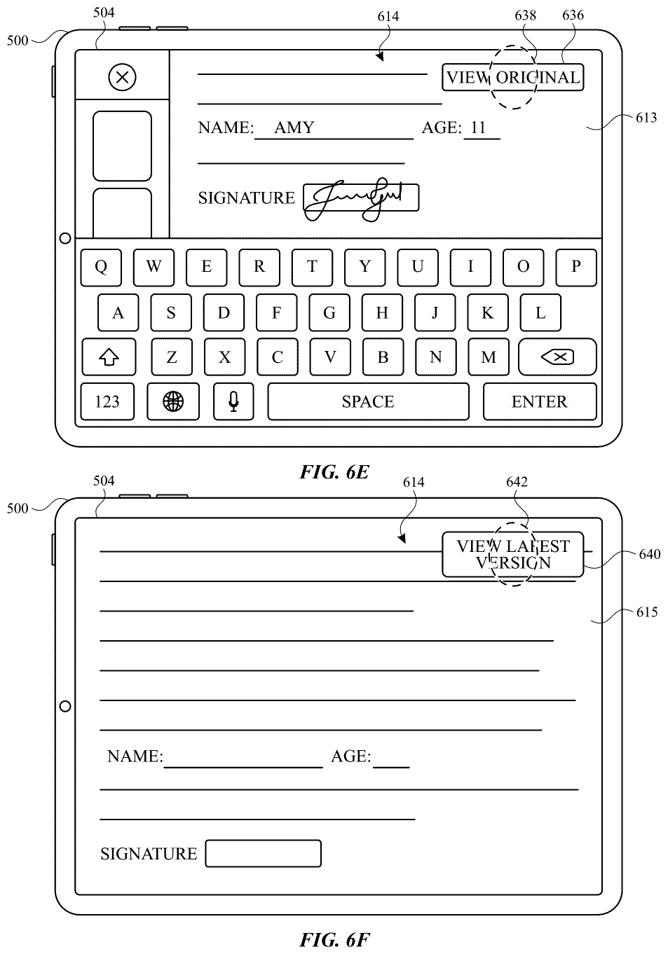

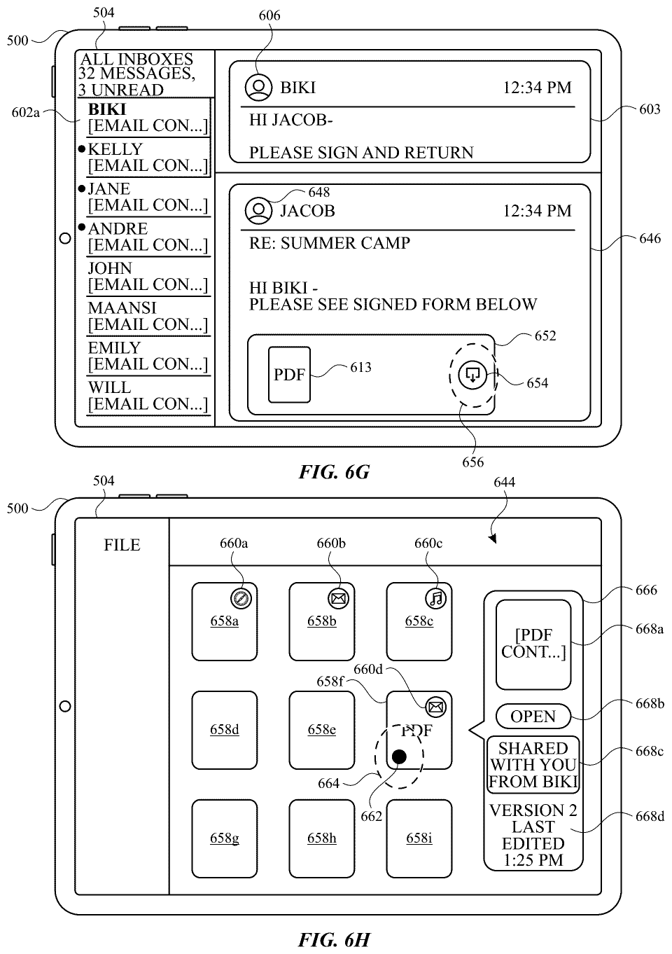

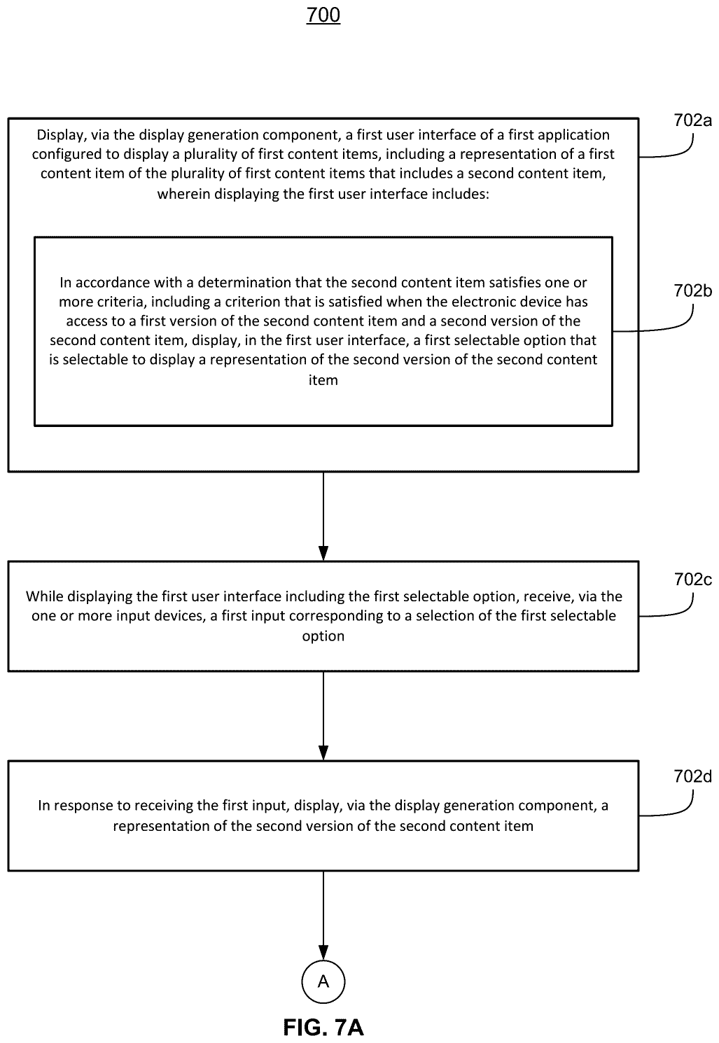

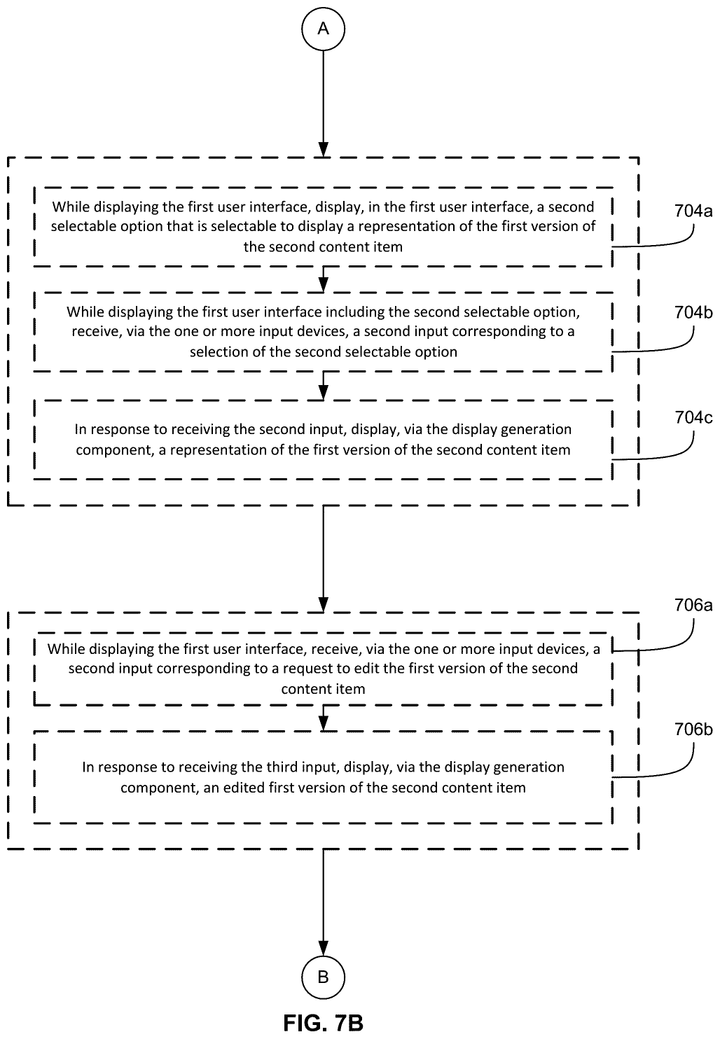

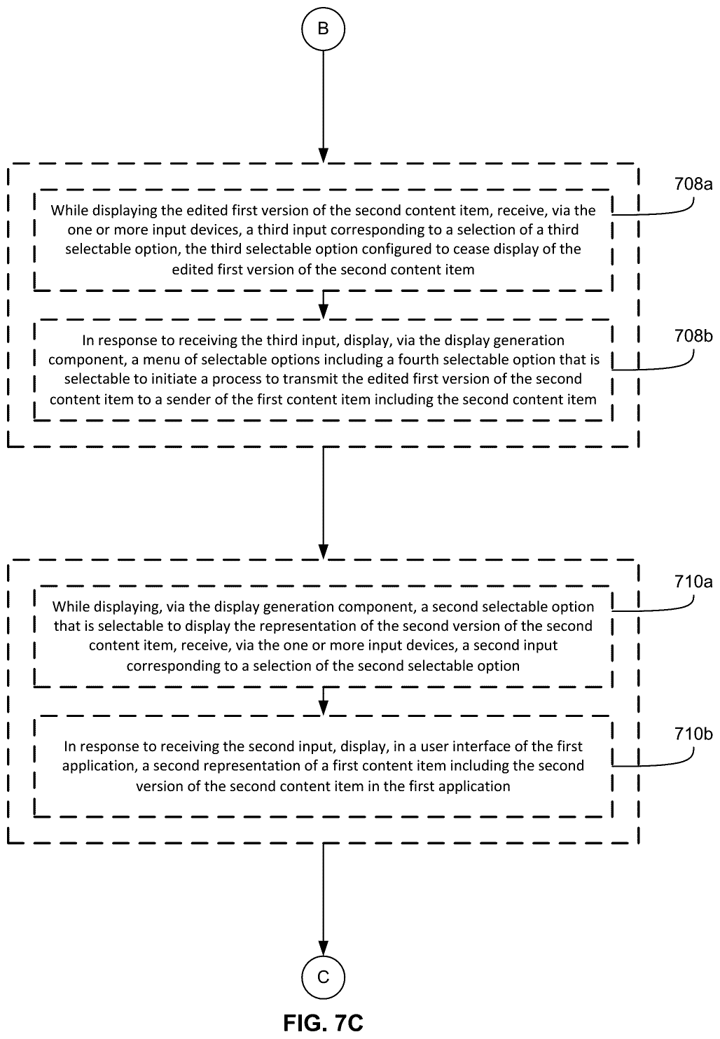

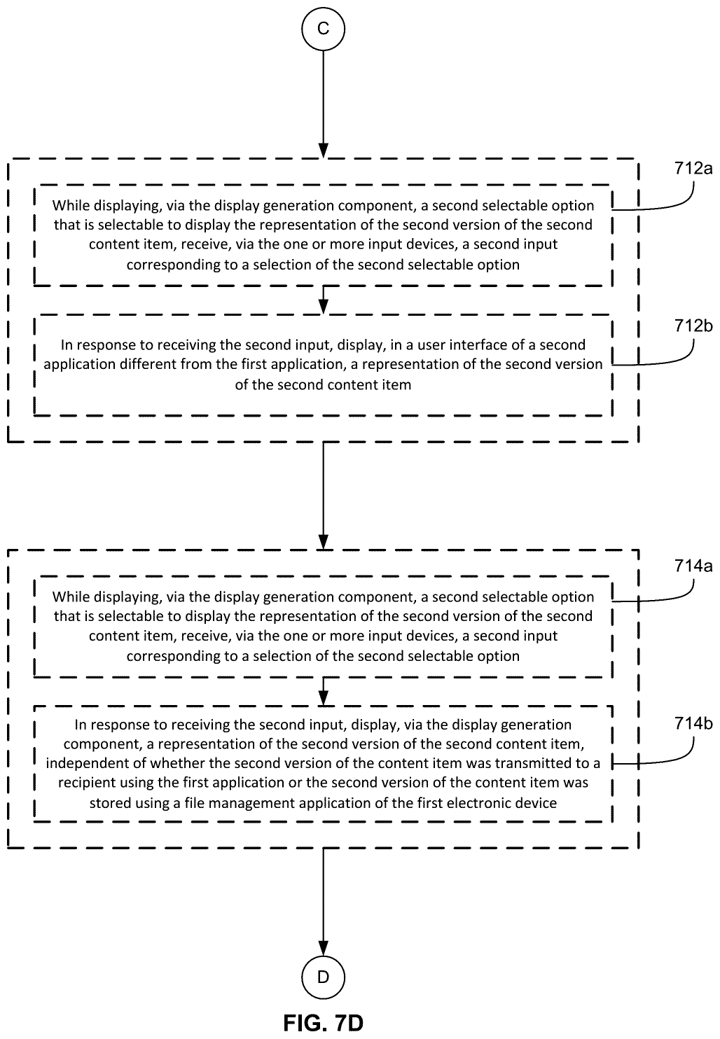

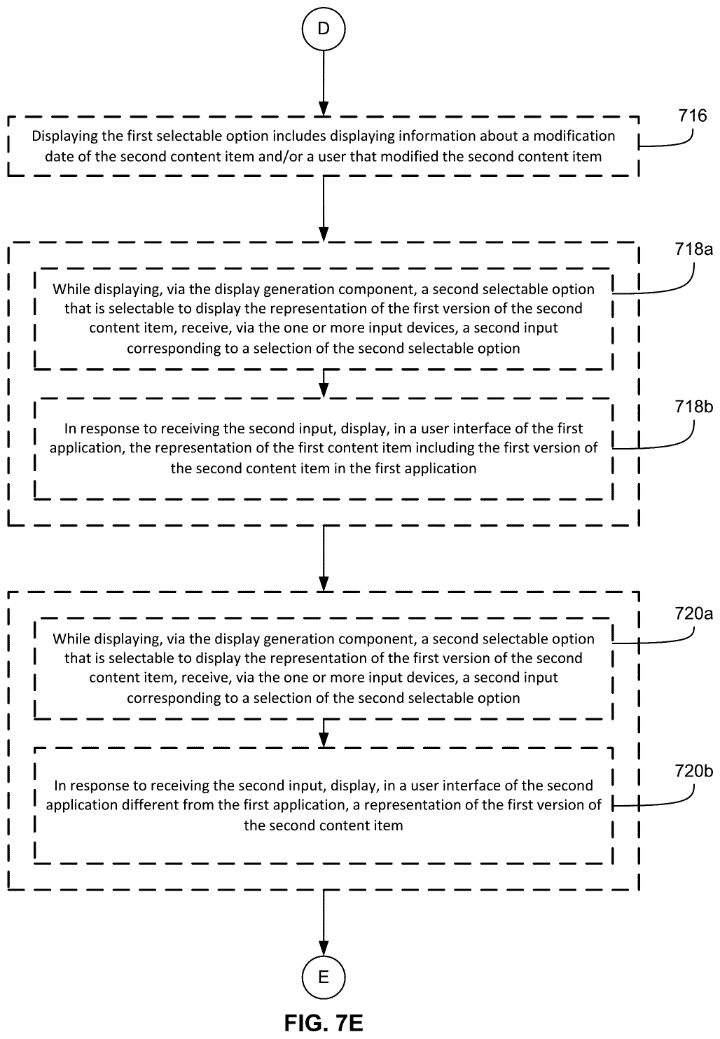

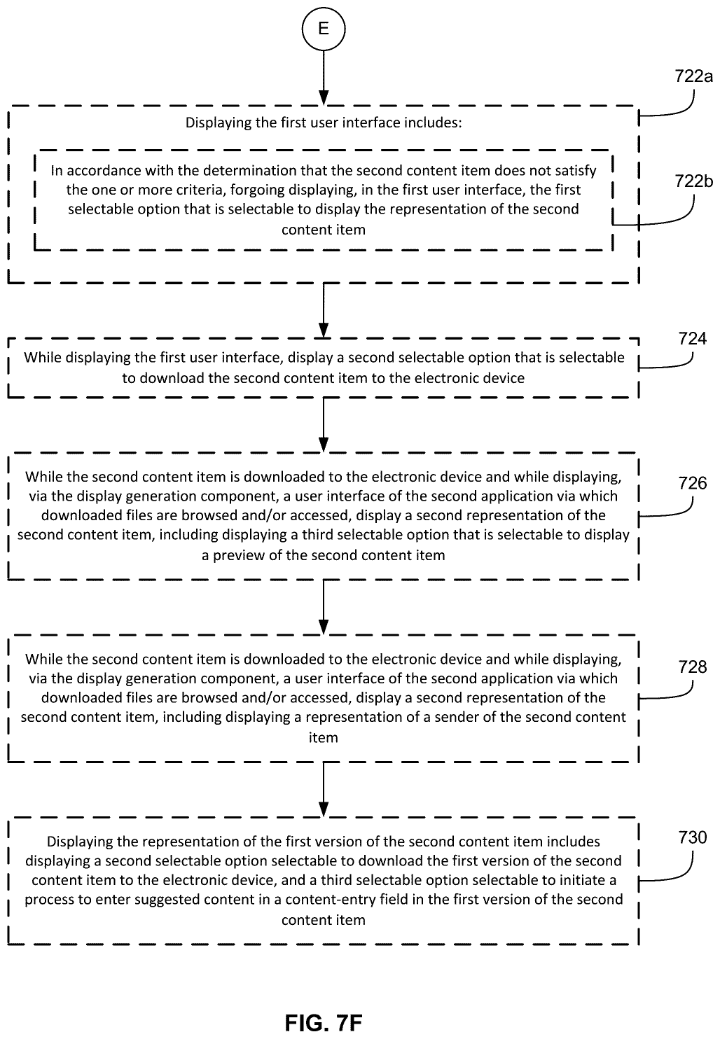

FIGS. 6A-6H illustrate exemplary ways in which an electronic device facilitates version tracking of documents based on actions associated with the document in accordance with some embodiments of the disclosure. The embodiments in these figures are used to illustrate the processes described below, including the processes described with reference to FIGS. 7A-7F.

FIG. 6A illustrates electronic device 500 displaying user interface 600 (e.g., via a display device, via a display generation component, or via a touch screen). In some embodiments, user interface 600 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500.

In some embodiments, user interface 600 is a user interface of a content storage application. For example, the content storage application is a mail application, a files application, a web browser application and/or a notes application, or any other application that includes or can store content and/or via which content is accessible. In some embodiments, the content storage application is an application installed on device 500.

In FIG. 6A, user interface 600 is a mail application with a plurality of mail items 602a-h. In response to a selection input with contact 604 (such as described in method 700) on mail item 602a, device 500 opens a mail item 602a and displays a user interface object 603 representing the contents of the mail item 602a. Mail item 602a is an email from a sender, Biki (indicated by the representation 606 of Biki), to a user, Jacob (the user associated with device 500). User interface object 603 includes an attachment of an original second content item 615, different than the mail item 602a, as described with reference to method 700. In some embodiments, the second content item 615 is a file (e.g., a PDF, music file, Word document, or a video file). In some embodiments, user interface object 603 includes a visual representation of the second content item 615 (e.g., a first version of the second content item) shown as first selectable option 608. In some embodiments, user interface object 603 also includes a second selectable option 610, that when selected initiates a download of the second content item 615 to device 500, as discussed in method 700 and in further detail below. In some embodiments, in response to a selection input with contact 612 directed towards the first selectable option 608, device 500 displays the contents of the second content item 613.

In some embodiments, device 500 displays the contents of the second content item 615 within the same application (e.g., the content storage application). In some embodiments, device 500 displays the contents of the second content item 615 in a second application (e.g., a music player for a music file, a PDF viewer application for a PDF, and/or a video player for a video file). As shown in FIG. 6B, device 500 displays a second user interface 614 for displaying the contents of the second content item 615 (e.g., a PDF file). FIG. 6B shows an edited second content item 613, as discussed in further detail below. In some embodiments, device 500 displays an unedited version of the second content item in response to the selection of option 608. FIG. 6B shows an edited second content item 613, which has been edited in response to user inputs as described below. In some embodiments, the second user interface 614 is a user interface of the content storage application. Alternatively, the second user interface 614 is a user interface of a second application (e.g., a document viewer application).

In some embodiments, second user interface 614 includes one or more selectable options 616a-c associated with the edited second content item 613 and/or second content item 615. In some embodiments, selectable option 616a is selectable to cease the display of the edited second content item 613 without saving any edits to the edited second content item 613. In some embodiments, selectable option 616b is selectable to cause the device 500 to enter a content entry mode. For example, in FIG. 6B, selectable option 616b is selected, as shown by the visual effect (e.g., highlighting, bolding, shading, and/or coloring) that indicates that the content entry mode is active on selectable option 616b. As a result, the electronic device 500 activates a text entry mode for the second content item 613. In some embodiments, as described herein below, while the text entry mode is active at the electronic device 500, the electronic device 500 provides for entering text (e.g., font-based text) in the second user interface 614 in response to detecting user input directed to the second content item 613. In some embodiments, as described below, the electronic device 500 provides for entering text in the edited second content item 613 by displaying text-entry fields.

As mentioned above, while the content entry mode is active for the second content item 613, the electronic device 500 facilitates entering text in the second content item 613 in response to detecting user input directed to selectable option 616b. In some embodiments, the electronic device 500 facilitates entering text into the second content item 613 based on a structure of the second content item 613. For example, in FIG. 6B, when the electronic device 500 activates the content entry mode (e.g., in response to detecting selection of the selectable option 616b), the electronic device 500 evaluates metadata associated with the second content item 613 to determine whether the second content item 613 includes any preset text-entry regions. In some embodiments, if the electronic device 500 determines that the second content item 613 includes one or more preset text-entry regions, the electronic device 500 displays the one or more preset text-entry regions with a visual effect. For example, in FIG. 6B, the electronic device 500 determines that the second content item 613 includes preset text-entry regions 618a-c. Accordingly, as shown in FIG. 6B, the electronic device 500 optionally highlights, shades, boldens, and/or colors the preset text-entry regions 618a-c indicating that input directed to the text-entry regions 618a-c causes the electronic device 500 to facilitate text entry into the text-entry regions 618a-c. For example, if the electronic device 500 detects an input (e.g., a selection input, such as a tap or touch input) directed to the preset text-entry regions 618a-c, the electronic device 500 displays a soft keyboard for entering text into the preset text-entry regions 616a-c, and/or one or more user interface objects 620 that are selectable to enter suggested text into the preset text-entry regions 618a-c. For example, a selection input directed to text-entry region 618a results in the electronic device 500 displaying one or more user interface objects 620, that when selected, initiates entry of corresponding text into the text-entry region 618a. For example, an input directed towards the selectable text “Amy” in user interface object 620 results in the text “Amy” being displayed in the text-entry region 618a, as shown in FIG. 6E.

In some embodiments, while displaying the second user interface 614, the electronic device 500 receives handwritten inputs. In some embodiments, the device 500 detects a contact with touch screen 504 provided by a stylus (e.g., controlled by the user of the device 500) while in the second user interface 614, such as a handwriting movement. In response to the input, the device 500 displays a representation of the handwritten input 622 in the second user interface 614. In some embodiments, the device 500 displays the handwritten input 622 anywhere in the second content item 613 in response to detecting a handwriting movement. In some embodiments, the input is not limited to inputs in the text-entry region 618a-c, although, the handwritten input 622 can be displayed on the text-entry regions 618a-c, as shown in FIG. 6B. In some embodiments, the handwritten input 622 is detected in the area of the text-entry region 618c in FIG. 6B, therefore it is shown in text-entry region 618c.

In some embodiments, in response to detecting a selection input provided by a contact 625 on option 616c in FIG. 6B, which is selectable to finish editing (e.g., inputting text into text-entry regions and/or inputting handwriting onto the second content item) the second content item 613, a menu 624 is displayed, as shown in FIG. 6C. In some embodiments, the menu 624 includes a plurality of selectable options 626a-d. In some embodiments, option 626a is selectable to initiate a process to transmit the edited second content item 613 back to the sender of the second content item (e.g., Biki), as discussed in FIG. 6A. For example, the process in response to selecting option 626a includes replying to the email from Biki with the edited second content item 613 as the attachment. In some embodiments, the selection of option 626a, such as with contact 628, causes device 500 to redisplay user interface 600 with a second user interface object representing a reply email to Biki from the user associated with the device 500 (Jacob), discussed in further detail in FIG. 6G. In some embodiments, option 626a includes a visual indication(s) and/or representation(s) 606 of the sender(s) of the second content item (Biki). For example, the visual indication(s) and/or representation(s) 606 includes photos, avatars, or other images corresponding to the sender(s). In some embodiments, option 626b is selectable to initiate a process to create a new mail item including the edited second content item 613 as the attachment. For example, the process in response to selection of option 626 includes redisplaying user interface 600 with a second user interface object displayed with a representation of the edited second content item 613. In some embodiments, the second user interface object is not automatically addressed to the sender of the first version of the second content item 615. In some embodiments, option 626c is selectable to save the edited second content item 613 to a second application (e.g., a files application). In some embodiments, the selection of option 626c, such as with contact 630, causes device 500 to display a third user interface 644 (e.g., a user interface of the files application), wherein the edited second content item 613 is saved, as discussed further detail in FIG. 6H. In some embodiments, option 626d is selectable to revert edited second content item 613 to the unedited version of the second content item (e.g., second content item 615).

In some embodiments, after selecting any of options 626a-c, a user of device 500 provides input to device 500 to redisplay mail item 602a in user interface 600. FIG. 6D illustrates user interface 600 with user interface object 603 displayed. User interface object 603 in FIG. 6D has one or more characteristics of user interface object 603 as described with reference to FIG. 6A, except as indicated below. In some embodiments, user interface object 603 includes a third selectable object 632. In some embodiments, third selectable object 632 is displayed in the user interface object 603 (the original email with the second content item 615) as a result of a user of device 500 saving and/or sending a representation of the edited second content item 613, as described with reference to FIG. 6C. In some embodiments, third selectable object 632 includes text describing the edited version of the second content item 613. For example, third selectable object 632 includes text describing when the second content item 615 was edited into edited second content item 613, the user and/or the user account that edited the second content item 613, and/or where the edited second content item 613 originated from (e.g., in an email from Biki). In FIG. 6D, the selection of option 608 optionally causes the device 500 to display the original version of the second content item (e.g., as shown in FIG. 6F), which can be edited to be the edited second content item 613.

In FIG. 6D, device 500 receives an input from a contact 634 directed towards the third selectable option 632. In response to the input, device 500 displays the second user interface 614 including a representation of the edited second content item 613, shown in FIG. 6E (e.g., the edited second content item 613 after selecting options 626a-c as described in FIG. 6C). In some embodiments, while displaying the representation of the edited second content item 613, device 500 also displays selectable options 616a-c, shown in FIG. 6B to edit and/or save a third version of the second content item. In some embodiments, the second user interface 614 includes a selectable option 636, shown in FIG. 6E, selectable to display a representation of the original second content item 615 in the second user interface 614. In some embodiments, selectable option 636 is not displayed in the second user interface 614 if the second content item has not been edited. Alternatively or additionally, and in some embodiments wherein the edited second content item 613 is saved at a location in device 500, in response to selecting third selectable option 632 shown in FIG. 6D, device 500 displays a third user interface 644 where the representation of the second content item 613 is saved, such as described in FIG. 6H and with reference to method 700. Alternatively or additionally, and in some embodiments, if the edited second content item 613 has been sent to a different device (e.g., such as through user interface 600), the selection of selectable option 636 results in device 500 displaying a user interface object in the first user interface 600 wherein the representation of the edited second content item 613 is attached, such as described with reference to FIG. 6G and method 700.

In some embodiments, device 500 receives an input from a contact 638 (e.g., a tap to select) on option 636 to cause display of edited second content item 613 in FIG. 6E. In response to the input, device 500 displays the second user interface 614 including a representation of the original second content item 615, shown in FIG. 6F. Alternatively or additionally, in some embodiments, in response to the input, device 500 displays the user interface object 603 (the original location of the second content item 615) including the original attachment of second content item 615 in user interface 600, such as described in FIG. 6A, and in method 700. Alternatively or additionally, in some embodiments, in response to the input, device 500 displays third user interface 644, where the second content item 615 is saved, as shown in FIG. 6H.

In some embodiments, while displaying the representation of the original second content item 615 in FIG. 6F, device 500 also displays selectable options 616a-c, shown in FIG. 6B, to edit and/or save a different version of the second content item. In some embodiments, the second user interface 614 includes a selectable option 640, that is selectable to display a representation of the edited second content item 613 in the second user interface 614, which is discussed in further detail in FIG. 6E. Alternatively or additionally, in some embodiments, the selection of option 640 causes device 500 to display user interface object 646 including the attachment of edited second content item 613 in user interface 600, such as described in FIG. 6G, and in method 700. Alternatively or additionally, in some embodiments, the selection of option 640 causes device 500 to display user interface 644 wherein the representation of the edited second content item 613 is stored and/or located, such as described with reference to FIG. 6H and method 700.

As discussed above, in response to the selection of option 640 in FIG. 6F and/or the selection of option 632 in FIG. 6D, the device 500 displays user interface 600 with a second user interface object 646 representing the contents of a reply mail item shown in FIG. 6G. In some embodiments, the reply mail item is an email from the user of the device 500, Jacob, to the sender(s) of mail item 602a, Biki. In some embodiments, second user interface object 646 includes a representation 648 of the sender of the reply mail item (Jacob). In some embodiments, the device 500 displays the second user interface object 646 in response to receiving an input from a contact (e.g., contact 628) directed towards sending the edited second content item 613 back to a sender, such as described in FIG. 6C and in method 700. In some embodiments, the second user interface object 646 includes a first selectable option 652 including a visual representation of the edited second content item 613. In some embodiments, the first selectable option 652 is selectable to cause device 500 to display the contents of the second content item 613, such as described in FIG. 6E, and in method 700. In some embodiments, the second user interface object 646 includes a second selectable option 654 that is selectable to download the edited second content item to a desired location on device 500 (e.g., a files application).

In some embodiments, device 500 receives an input from a contact 656 directed towards the second selectable option 654 in FIG. 6G. In response to the selection of option 654, the device 500 saves the file (e.g., edited second content item 613) to a specified location (e.g., a files application including third user interface 644). In some embodiments, in response to the selection of option 654 or after selection of option 654, the device 500 displays the third user interface 644 (e.g., in response to user input to do so), where the second content item 613 had been downloaded to. In some embodiments, the third user interface 644, shown in FIG. 6H, is a user interface of a files application. In some embodiments, third user interface 644 includes visual representations (e.g., icons) of a plurality of representations of files 658a-i that have been saved to device 500 and/or the files application. In some embodiments, the plurality of files includes a plurality of file types. For example, the files include MP3 files, JPEG files, PDF files, DOC files, PNG files, MOV files, and/or keynote files. In some embodiments, the representation of files 658a-i include a visual representation (e.g., 660a-c) of a source location. For example, a source location may include different applications such as a web browser application, a mail application, a music application, or other applications. In some embodiments, the visual representation of the source location has different visual appearances as a function of the source location. In some embodiments, the visual representation of the source location is overlaid on the representation of files 658a-i. For example, representation of file 658a includes a representation 660a of a web browser application, which is the result of representation of file 658a being downloaded from a web browser application. Representation of file 658b includes a representation 660b of a mail application which is the result of representation of file 658b being downloaded from a mail item in the mail application. Representation of file 658c includes a representation 660c of a music application, which is the result of representation of file 658c being downloaded from a mail application. In some embodiments, though not shown, files 658d, 658c, 658g-i are also displayed with a representation of a source location in embodiments where they are downloaded from a different application. In some embodiments, representation of file 658f is a representation of the edited second content item 613. In some embodiments, device 500 detects a selection (e.g., a tap, a long tap, and/or a right click of a mouse) of a selectable option 662 (which is optionally present on all files 658a-i) using contact 664. In some embodiments, option 662 is not visually present/displayed and a selection of a representation of a file 658a-i, as described above, results in device 500 displaying menu 666. In some embodiments, the selection of selectable option 662 results in device 500 displaying menu 666.

In some embodiments, the menu 666 includes a plurality of user interface objects 668a-d. In some embodiments, object 668a is a preview of the contents of representation of file 658f (e.g., a preview of second content item 613). In some embodiments, object 668b is a selectable object selectable to open the representation of file 658f. For example, the selection of object 668b results in device 500 displaying second user interface 614 and the representation of second content item 613, as shown in FIG. 6E. In some embodiments, object 668c is a selectable object selectable to open the original location of representation of file 658f. For example, the selection of object 668c causes device 500 to display user interface 600 and the user interface object 646 including the edited second content item 613 (the latest version), as described in FIG. 6G. In some embodiments, object 668c includes text describing the sender of the representation of file 658f. In some embodiments, object 668d is an object including text describing the history of the editing of representation of file 658f. For example, the text includes the version of the file and/or a date/time at which the version was created. For example, the edited second content item 613 is a second version of the second content item 615.

FIGS. 7A-7F is a flow diagram illustrating a method in which an electronic device facilities version tracking of documents based on actions associated with the document. The method 700 is optionally performed at first and/or electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

As described below, the method 700 provides ways in which an electronic device facilities version tracking of documents based on actions associated with the document. Displaying a user interface with a selectable option that is selectable to display a representation of the second version of the content item provides a quick and efficient way to access a more recent version of a content item, thereby reducing the likelihood of erroneous inputs directed to the electronic device.

In some embodiments, method 700 is performed at an electronic device (e.g., electronic device 500, shown in FIG. 6A through 6H) in communication with a display generation component and one or more input devices. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, the electronic device displays (702a), via the display generation component, a first user interface (e.g., user interface 600 shown in FIG. 6A) of a first application configured to display a plurality of first content items (e.g., mail item 602a-h shown in FIG. 6A) (e.g., e-mail application displaying emails, a messaging application displaying messages, a notes app displaying notes, a web browser displaying content of a first type, or a files application displaying files or other content of a first type), including a representation of a first content item (e.g., user interface object 603 shown in FIG. 6A and/or user interface object 646 in FIG. 6G) of the plurality of first content items that includes a second content item (e.g., original second content item 615 shown in FIG. 6A and/or edited second content item 613 shown in FIG. 6G) (e.g., PDF document JPEG file, MP3 file, PowerPoint document, word document, or other content of a second type, different from the first type that is included in or embedded in the first content item of the first type). For example, the second content item is optionally embedded in and/or attached to the first content item, such as a PDF file sent as an attachment in an email.

In some embodiments, in accordance with a determination that the second content item satisfies one or more criteria, including a criterion that is satisfied when the electronic device has access to a first version of the second content item (e.g., original second content item 615 shown in FIGS. 6A and 6F) (e.g., an unedited version of the second content item, such as the second content item as originally received by the electronic device as part of the first content item) and a second version of the second content item (e.g., edited second content item 613 shown in FIG. 6E and FIG. 6G) (e.g., an edited version of the second content item, such as edited at the electronic device after receiving the second content item as originally received by the electronic device as part of the first content item), the electronic device displays (702b), in the first user interface (optionally concurrently with the content (e.g., text and/or graphics) of the first content item), a first selectable option that is selectable to display a representation of the second version of the second content item, such as shown my selectable option 632 in FIG. 6D. In some embodiments, the first selectable option is located below, on top of, to the right, or to the left of the representation of the second content item displayed within and/or concurrently with the representation of the first content item. In some embodiments, the first selectable option includes a label or other textual descriptor describing the version of the second content item. For example, the label indicates when the second version was created (e.g., date and/or time) and/or where the second content item originated from (e.g., the sender of the email in which the second content item was included).

In some embodiments, while displaying the first user interface including the first selectable option, the electronic device receives (702c), via the one or more input devices, a first input corresponding to a selection of the first selectable option, show as shown by contact 634 directed towards option 632 in FIG. 6D. In some embodiments, the first input includes a user interaction with the first selectable option, such as tapping on a touch-sensitive screen using a finger. In other embodiments, the first input includes a user interaction of the above user interactions with a mouse or trackpad, such as clicking with a mouse or a trackpad.

In some embodiments, in response to receiving the first input, the electronic device displays (702d), via the display generation component, a representation of the second version of the second content item, such as shown by edited second content item 613 in FIG. 6E (optionally including displaying the content (e.g., text and/or graphics) of the second version of the second content item). In some embodiments, the second version of the second content item includes edits to the first version of the second content item (e.g., as edited at the electronic device after receiving the second content item as originally received by the electronic device as part of the first content item). For example, edits to the first version of the second content item includes adding information in fillable spaces in the second content item, adding redlining, or deleting content in the second content item. In some embodiments, the representation of the first and/or second version of the second content item is displayed within the first application (e.g., in a user interface of the first application). In some embodiments, the representation of the first and/or second version of the second content item is displayed in a second application, different than the first application, that corresponds to the second content item. In some embodiments, the second content item is edited in the second application and/or in the first application. Displaying a user interface with a selectable option that is selectable to display a representation of the second version of the content item provides a quick and efficient way to access a more recent version of a content item, thereby reducing the likelihood of erroneous inputs directed to the electronic device.

In some embodiments, while displaying the first user interface, the electronic device displays (704a), in the first user interface, a second selectable option that is selectable to display a representation of the first version of the second content item, such as selectable option 608 shown in FIG. 6D. In some embodiments, displaying the first user interface includes displaying the representation of the first content item. In some embodiments, the second selectable option is a representation of the second content item displayed within the representation of the first content item. For example, an email optionally includes a PDF attachment or other file attachment that is selectable to display a representation of the PDF or other attachment.

In some embodiments, while displaying the first user interface including the second selectable option, the electronic device receives (704b), via the one or more input devices, a second input corresponding to a selection of the second selectable option, such as if contact 612, shown in FIG. 6A, was directed to selectable option 608 in FIG. 6D. In some embodiments, the second input has one or more characteristics of the first input described above.

In some embodiments, in response to receiving the second input, the electronic device displays (704c), via the display generation component, a representation of the first version of the second content item, such as in second user interface 614 in FIG. 6F. In some embodiments, the representation of the first version of the second content item includes displaying the content (e.g., text and/or graphics) of the first version of the second content item. In some embodiments, the representation of the first version of the second content item is displayed in a second application with a second user interface, different from the first user interface. Displaying a user interface with a selectable option that is selectable to display a representation of the first version of the content item provides a quick and efficient way to access the original version of a content item, thereby reducing the likelihood of erroneous inputs directed to the electronic device.

In some embodiments, while displaying the first user interface, the electronic device receives (706a), via the one or more input devices, a second input corresponding to a request to edit the first version of the second content item, such as the input directed towards text-entry regions 616a-c and/or the handwritten input 616, as described in FIG. 6B. In some embodiments, the second input corresponds to a request to display the visual representation of the first version of the second content item. In some embodiments, the second input includes one or more characteristics of the first input described above. In some embodiments, the second input is directed towards a second selectable option selectable to edit the second content item. In some embodiments, the second input includes a typing input. In some embodiments, the typing input includes tapping with an object (e.g., a finger) on a representation of a keyboard on a touch sensitive surface. In some embodiments, the typing input includes typing on an input device (e.g., a keyboard). In some embodiments, the second input includes a drawing input. In some embodiments, the drawing input is provided by an object, such as a stylus, digital pen, or similar input device or a portion of the user's body (e.g., finger). In some embodiments, the electronic device detects the location of the object or a portion of the object (e.g., the tip of the stylus) using an input device, such as a touch sensitive surface.

In some embodiments, in response to receiving the third input, such as contact 615 directed towards selectable option 616c in FIG. 6B, the electronic device displays (706b), via the display generation component, an edited first version of the second content item, such as second content item 613 shown in FIG. 6B. In some embodiments, the edited first version of the second content item, once saved or transmitted, as discussed below, becomes the second version of the second content item. In some embodiments, the edited first version of the second content item includes additional text, writing, pictures, songs, and/or drawings provided via user input, as described above. In some embodiments, the edited first version of the second content item includes deleted text and/or content. In some embodiments, content items are edited with input while displayed in the first user interface. Displaying edits to the second content item in response to receiving the third input reduces the number of inputs needed to edit the second content item and provides visual feedback that the second content item has been edited, thereby improving user-device interaction.

In some embodiments, while displaying the edited first version of the second content item, the electronic device receives (708a), via the one or more input devices, a third input corresponding to a selection of a third selectable option, the third selectable option configured to cease display of the edited first version of the second content item, such as contact 625 directed towards selectable option 616c in FIG. 6B. In some embodiments, the third input has one or more characteristics of the first input. In some embodiments, the third selectable option indicates the completion of the edits to the first version of the second content item.

In some embodiments, in response to receiving the third input, the electronic device displays (708b), via the display generation component, a menu of selectable options (e.g., menu 624 shown in FIG. 6C) including a fourth selectable option that is selectable to initiate a process to transmit the edited first version of the second content item to a sender of the first content item including the second content item, such as option 626a in FIG. 6C. In some embodiments, the menu of selectable options also includes selectable options to transmit the edited first version of the second content item to other people (e.g., a person other than the sender of the first content item), to save the edited first version of the second content item in a second application (e.g., in files), and/or to discard any edits to the first version of the second content item. In some embodiments, the fourth selectable option includes a visual representation of the sender of the first content item (e.g., an avatar or a picture of the sender). In some embodiments, the process to transmit the edited first version of the second content item includes displaying a second representation of a first content item (e.g., a reply email) including (e.g., as an attachment) a representation of the edited first version of the second content item. In some embodiments, the edited first version of the second content item is transmitted back to the sender of the second content item using the first application and the first user interface. Displaying a menu of selectable options that includes an option to initiate a process to send the edited second content item back to the sender provides a quick and efficient way to send an edited content item, thereby reducing the likelihood of erroneous inputs directed to the electronic device.

In some embodiments, while displaying, via the display generation component, a second selectable option that is selectable to display the representation of the second version of the second content item, such as option 640 in FIG. 6F, (e.g., while displaying the representation of the first version of the second content item), the electronic device receives (710a), via the one or more input devices, a second input corresponding to a selection of the second selectable option, such as with contact 642 shown in FIG. 6F. The second input has one or more characteristics of the first input described above. In some embodiments, the second selectable option is displayed after the first version of the second content item has been edited. In some embodiments, the second selectable option is displayed in the first user interface or while displaying the first version of the second content item.

In some embodiments, in response to receiving the second input, the electronic device displays (710b), in a user interface of the first application, a second representation of a first content item including the second version of the second content item in the first application, such as the edited second content item 613 in user interface object 646 of user interface 600, shown in FIG. 6G. For example, the second version of the second content item is displayed as included in a reply email (e.g., the second representation of the first content item) to the original email including the first version of the first content item. In some embodiments, the second version of the second content item is the edited first version of the second content item, as discussed above. In some embodiments, the second representation of the first content item includes text and/or graphics along with the second version of the second content item. In some embodiments, the second representation of the first content item includes a third selectable option selectable to display the representation of the second version of the second content item. Displaying a selectable option that is selectable to display a representation of the second version of the second content item while viewing the first version of the second content item provides a quick and efficient way to access a location of the second version of the second content item, thereby reducing the likelihood of erroneous inputs directed to the electronic device.

In some embodiments, while displaying, via the display generation component, a second selectable option that is selectable to display the representation of the second version of the second content item, such as selectable option 640 shown in FIG. 6F. (e.g., while displaying the representation of the first version of the second content item), the electronic device receives (712a), via the one or more input devices, a second input corresponding to a selection of the second selectable option, such as with contact 642 shown in FIG. 6F. The second input has one or more characteristics of the first input described above. In some embodiments, the second selectable option is displayed after the first version of the second content item has been edited. In some embodiments, the second selectable option is displayed in the first user interface or while displaying the first version of the second content item.

In some embodiments, in response to receiving the second input, the electronic device displays (712b), in a user interface of a second application different from the first application, a representation of the second version of the second content item, such as the display of the representation of file 658f in third user interface 644, shown in FIG. 6H. For example, the second application is optionally a file access, browsing and/or management application. In some embodiments, the second application stores a plurality of content items and/or provides access to content items that are stored on the electronic device. In some embodiments, the second application stores the second version of the second content item in a location separate from the first application. In some embodiments, the second version of the second content item is displayed with representations of other files/content items stored on the electronic device in the second application. In some embodiments, the representations of files/content items are selectable to display the files/contents. In some embodiments, the electronic device includes other locations (e.g., folder) accessible from the second application that do not include the second version of the second content item. In some embodiments, selecting the second selectable option includes the display of a particular location in the second application where the second version of the second content item is stored. In some embodiments, selecting a different selectable option configured to display a different content item (e.g., to display a second or more or most recent version of the different content item) results in the display of a particular location in the second application at which the different content item is stored (which is optionally different than where the second version of the second content item is stored). Displaying the representation of the second version of the second content item in response to receiving an input to a selectable option provides a quick and efficient way to access the location at which the second version of a content item is stored, thereby reducing the likelihood of erroneous inputs directed to the electronic device.

In some embodiments, while displaying, via the display generation component, a second selectable option that is selectable to display the representation of the second version of the second content item, such as selectable option 640 in FIG. 6F, the electronic device receives (714a), via the one or more input devices, a second input corresponding to a selection of the second selectable option, as described above with reference to FIG. 6F. The second input has one or more characteristics of the first input described above. In some embodiments, the second selectable option is displayed after the first version of the second content item has been edited. In some embodiments, the second selectable option is displayed in the first user interface or while displaying the first version of the second content item.

In some embodiments, in response to receiving the second input, the electronic device displays (714b), via the display generation component, a representation of the second version of the second content item, independent of whether the second version of the content item was transmitted to a recipient using the first application or the second version of the content item was stored using a file management application of the first electronic device, such as the display of the contents of edited second content item 613 in second user interface 614, shown in FIG. 6E. For example, in response to selecting the second selectable option, a PDF (e.g., the second version of the second content item) is displayed. In some embodiments, the representation of the second version of the second content item is displayed in the first application. In some embodiments, the representation of the second version of the second content item is displayed in a second application (e.g., a PDF viewer application, a music player application, a web browser, or the like). In some embodiments, in response to receiving the second input, the user interface of the first application and/or the user interface of the second application are not displayed. Displaying the representation of the second version of the second content item in response to receiving an input to a selectable option provides a quick and efficient way to access the second version of a content item, thereby reducing the likelihood of erroneous inputs directed to the electronic device.

In some embodiments, displaying the first selectable option includes displaying information about a modification date of the second content item and/or a user that modified the second content item (716), such as shown in option 632 in FIG. 6D. For example, the modification date optionally includes a date and/or a time that the second content item was last modified (e.g., to result in the second version of the second content item). In some embodiments, the modification date of the second content item is a date/time at which the first version of the second content item becomes the second version of the second content item (e.g., edited first version of the second content item). In some embodiments, the first selectable option includes and/or is displayed with a name or other representation (e.g., avatar) of the user that modified the second content item. Displaying information about the modification date of the second content item and/or a user that modified the second content item provides quick and efficient access to information about the second content item, thereby reducing the likelihood of erroneous inputs directed to the electronic device.

In some embodiments, while displaying, via the display generation component, a second selectable option that is selectable to display the representation of the first version of the second content item, such as option 636 shown in FIG. 6E, the electronic device receives (718a), via the one or more input devices, a second input corresponding to a selection of the second selectable option, such as with contact 638 in FIG. 6E. The second input has one or more characteristics of the first input as described above. In some embodiments, the second selectable option is displayed in the second version of the second content item while the electronic device has access to both the first version and the second version of the second content item.

In some embodiments, in response to receiving the second input, the electronic device displays (718b), in a user interface of the first application, the representation of the first content item including (optionally as an attachment) the first version of the second content item in the first application, such as original content item 615 in user interface 600, shown in FIG. 6A. In some embodiments, the second selectable option is located at the top or bottom of the representation of the second version of the second content item. In some embodiments, the second selectable option includes a label describing that the second selectable option is selectable to display the representation of the first version of the second content item. For example, the representation of the first content item is an email from which the second content item originated. In some embodiments, the representation of the first content item includes a third selectable option selectable to display the representation of the first version of the second content item. In some embodiments, the representation of the first content item also includes the first selectable option, as discussed above. Displaying a selectable option that is selectable to display a representation of the first version of the second content item while viewing the second version of the second content item provides a quick and efficient way to access a location of the first version of the second content item, thereby reducing the likelihood of erroneous inputs directed to the electronic device.

In some embodiments, while displaying, via the display generation component, a second selectable option that is selectable to display the representation of the first version of the second content item, such as selectable option 636 in FIG. 6E (e.g., the second selectable option has one or more characteristics of the second selectable option as discussed above), the electronic device receives (720a), via the one or more input devices, a second input corresponding to a selection of the second selectable option, as described above with reference to FIG. 6E. The second input has one or more characteristics of the first input as described above. In some embodiments, the second selectable option is displayed in the second version of the second content item while the electronic device has access to both the first version and the second version of the second content item.

In some embodiments, in response to receiving the second input, the electronic device displays (720b), in a user interface of the second application different from the first application, a representation of the first version of the second content item, such as if representation of file 658f was a representation of the original second content item 615 in FIG. 6H. In some embodiments, the second application has one or more characteristics of the second application as discussed above. In some embodiments, the representation of the first version of the second content item is displayed with other representations of files/content items, as described above. Displaying the representation of the first version of the second content item in response to receiving an input to a selectable option provides a quick and efficient way to access the first version of a content item, thereby reducing the likelihood of erroneous inputs directed to the electronic device.

In some embodiments, in accordance with the determination that the second content item does not satisfy the one or more criteria (722a), the electronic device forgoes displaying (722b), in the first user interface, the first selectable option that is selectable to display the representation of the second content item, such as if selectable option 632, shown in FIG. 6D, is not displayed if edited second content item 613 is not located on device 500 and/or does not exist. For example, a user of the electronic device does not save a new version of the second content item (e.g., does not edit the second content item). In some embodiments, the second content item is modified on a second electronic device (e.g., a second version of the second content item) and is transmitted back to the sender of the second content item from the second device using the first application. The electronic device optionally has access to the second version of the second content item through the first application. Not displaying a selectable option to display a second version of the second content item when the second version is not accessible prevents erroneous inputs directed to the electronic device.

In some embodiments, while displaying the first user interface, the electronic device displays (724) a second selectable option that is selectable to download the second content item to the electronic device, such as option 654 shown in FIG. 6G. For example, a user selects the second selectable option to download the second content item to the electronic device, which is optionally accessible the second application, as described above. In some embodiments, the first version of the second content item and the second version of the second content item are downloadable to the electronic device. Displaying a selectable option to download the second content item provides a quick and efficient way to download the second content item to the electronic device.

In some embodiments, while the second content item (e.g., the first version of the second content item and/or the second version of the second content item) is downloaded to the electronic device and while the electronic device displays, via the display generation component, a user interface of the second application, such as third user interface 644 shown in FIG. 6H, (e.g., a files application) via which downloaded files are browsed and/or accessed, the electronic device displays (726) a second representation of the second content item, such as representation of file 658f in FIG. 6H, including displaying a third selectable option that is selectable to display a preview of the second content item, such as option 662 in FIG. 6H. In some embodiments, the third selectable option is displayed on the second representation of the second content item. In some embodiments, in response to an input, which has one or more characteristics of the first input described above, detected on the electronic device, the electronic device displays the preview of the second content item. In some embodiments, the third selectable option is located on a corner of the second representation of the second content item. In some embodiments, the third selectable option is selectable by an input include a long press using an object (e.g., a finger, a stylus, trackpad, or a mouse) or a right click using an object (e.g., a mouse or trackpad). In some embodiments, the preview of the second content item includes a visual representation of the contents of the second content item. Displaying a preview of the second content item in the second application provides a quick and efficient way to identify the second content item.

In some embodiments, while the second content item is downloaded to the electronic device and while displaying, via the display generation component, a user interface of the second application (e.g., third user interface 644 shown in FIG. 6H) via which downloaded files are browsed and/or accessed, the electronic device displays (728) a second representation of the second content item, including displaying a representation of a sender of the second content item, such as option 668c in FIG. 6H. In some embodiments, the second representation of the second content item includes information such as a date and/or the second content item was modified, a user that modified the second content item, and a selectable option to open a representation of the second content item. In some embodiments, the representation of the sender is a fourth selectable option is selectable to view the original location of the second content item (e.g., the representation of the first content item and/or the first content item including the second content item). For example, the fourth selectable option optionally opens an email from where the second content item originated from. Displaying the representation of the second of the second content item in the user interface of the second application provides a quick and efficient way to find the sender of the second content item, thereby improving user-devise interactions.

In some embodiments, displaying the representation of the first version of the second content item includes displaying a second selectable option selectable to download the first version of the second content item to the electronic device (730), such as option 610 in FIG. 6A, and a third selectable option selectable to initiate a process to enter suggested content (e.g., text, pictures, songs, videos or other content) in a content-entry field in the first version of the second content item, such as option 616b in FIG. 6B. In some embodiments, downloading the first version of the second content item includes downloading to a specified location, such as to the second application. In some embodiments, a user of the electronic device selects a download location. In some embodiments, the electronic device auto selects a download location (e.g., a downloads folder). In some embodiments, the electronic device generates the suggested content based on a context of a content-entry field. For example, the electronic device suggests names of contacts of a user of the electronic device if the content-entry field is requesting names. In some embodiments, the electronic device suggests songs if the content-entry field is requesting songs. In some embodiments, the third selectable option is not displayed if the second content item does not have content-entry fields. In some embodiments, selecting the third selectable option causes the electronic device to display selectable options (e.g., suggested content) for one or more content entry fields in the second content item. In some embodiments, the selectable options correspond to different suggested content to enter into the content entry field. In some embodiments, the selection of one of the selectable options results in the corresponding suggesting content to be entered into the content-entry field. In some embodiments, displaying the representation of the second version of the second content item includes displaying a second selectable option to download the second version of the second content item and a third selectable option to initiate a process to enter suggested content (e.g., text, pictures, songs, videos or other content) in a content-entry field in the second version of the second content item. Displaying user interface objects that are selectable to enter suggested text into a preset text-entry field in response to detecting input directed to a text-entry region reduces the number of inputs needed to enter text in the text-entry region and/or enables the text to be entered into the text-entry region automatically, thereby improving user-device interaction.

It should be understood that the particular order in which the operations in FIGS. 7A-7F have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIGS. 7A-7F are, optionally, implemented by components depicted in FIGS. 1A-1B. For example, displaying operation 702a, 702b, and 702d, and receiving operation 702c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, capturing and transmitting content can enable the user to view the content at a later time. Accordingly, use of such personal information data enables users to use electronic devices to view content. Further, other uses for personal information data that benefit the user are also contemplated by the present disclosure. For instance, personal information data may be used to track versions of various content.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device version tracks content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
displaying, via the display generation component, a first user interface of a first application configured to display a plurality of first content items, including a representation of a first content item of the plurality of first content items that includes a second content item, wherein displaying the first user interface includes:
in accordance with a determination that the second content item satisfies one or more criteria, including a criterion that is satisfied when the electronic device has access to a first version of the second content item and a second version of the second content item, displaying, in the first user interface, a first selectable option that is selectable to display a representation of the second version of the second content item;
while displaying the first user interface including the first selectable option, receiving, via the one or more input devices, a first input corresponding to a selection of the first selectable option; and
in response to receiving the first input, displaying, via the display generation component, a representation of the second version of the second content item.

2. The method of claim 1, further comprising:
while displaying the first user interface, displaying, in the first user interface, a second selectable option that is selectable to display a representation of the first version of the second content item;
while displaying the first user interface including the second selectable option, receiving, via the one or more input devices, a second input corresponding to a selection of the second selectable option; and
in response to receiving the second input, displaying, via the display generation component, a representation of the first version of the second content item.

3. The method of claim 1, further comprising:
while displaying the first user interface, receiving, via the one or more input devices, a second input corresponding to a request to edit the first version of the second content item; and
in response to receiving the second input, displaying, via the display generation component, an edited first version of the second content item.

4. The method of claim 3, further comprising:
while displaying the edited first version of the second content item, receiving, via the one or more input devices, a third input corresponding to a selection of a third selectable option, the third selectable option configured to cease display of the edited first version of the second content item; and
in response to receiving the third input, displaying, via the display generation component, a menu of selectable options including a fourth selectable option that is selectable to initiate a process to transmit the edited first version of the second content item to a sender of the first content item including the second content item.

5. The method of claim 1, further comprising:
while displaying, via the display generation component, a second selectable option that is selectable to display the representation of the second version of the second content item, receiving, via the one or more input devices, a second input corresponding to a selection of the second selectable option; and
in response to receiving the second input, displaying, in a user interface of the first application, a second representation of a first content item including the second version of the second content item in the first application.

6. The method of claim 1, further comprising:
while displaying, via the display generation component, a second selectable option that is selectable to display the representation of the second version of the second content item, receiving, via the one or more input devices, a second input corresponding to a selection of the second selectable option; and
in response to receiving the second input, displaying, in a user interface of a second application different from the first application, a representation of the second version of the second content item.

7. The method of claim 1, further comprising:
while displaying, via the display generation component, a second selectable option that is selectable to display the representation of the second version of the second content item, receiving, via the one or more input devices, a second input corresponding to a selection of the second selectable option; and
in response to receiving the second input, displaying, via the display generation component, a representation of the second version of the second content item, independent of whether the second version of the second content item was transmitted to a recipient using the first application or the second version of the content item was stored using a file management application of the electronic device.

8. The method of claim 1, wherein displaying the first selectable option includes displaying information about a modification date of the second content item and/or a user that modified the second content item.

9. The method of claim 1, further comprising:
while displaying, via the display generation component, a second selectable option that is selectable to display the representation of the first version of the second content item, receiving, via the one or more input devices, a second input corresponding to a selection of the second selectable option; and
in response to receiving the second input, displaying, in a user interface of the first application, the representation of the first content item including the first version of the second content item in the first application.

10. The method of claim 1, further comprising:
while displaying, via the display generation component, a second selectable option that is selectable to display the representation of the first version of the second content item, receiving, via the one or more input devices, a second input corresponding to a selection of the second selectable option; and
in response to receiving the second input, displaying, in a user interface of the second application different from the first application, a representation of the first version of the second content item.

11. The method of claim 1, wherein displaying the first user interface includes:
in accordance with the determination that the second content item does not satisfy the one or more criteria, forgoing displaying, in the first user interface, the first selectable option that is selectable to display the representation of the second content item.

12. The method of claim 1, further comprising:
while displaying the first user interface, displaying a second selectable option that is selectable to download the second content item to the electronic device.

13. The method of claim 12, further comprising:
while the second content item is downloaded to the electronic device and while displaying, via the display generation component, a user interface of a second application via which downloaded files are browsed and/or accessed, displaying a second representation of the second content item, including displaying a third selectable option that is selectable to display a preview of the second content item.

14. The method of claim 12, further comprising:
while the second content item is downloaded to the electronic device and while displaying, via the display generation component, a user interface of the second application via which downloaded files are browsed and/or accessed, displaying a second representation of the second content item, including displaying a representation of a sender of the second content item.

15. The method of claim 1, wherein displaying the representation of the first version of the second content item includes displaying a second selectable option selectable to download the first version of the second content item to the electronic device, and a third selectable option selectable to initiate a process to enter suggested content in a content-entry field in the first version of the second content item.

16. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
displaying, via the display generation component, a first user interface of a first application configured to display a plurality of first content items, including a representation of a first content item of the plurality of first content items that includes a second content item, wherein displaying the first user interface includes:
in accordance with a determination that the second content item satisfies one or more criteria, including a criterion that is satisfied when the electronic device has access to a first version of the second content item and a second version of the second content item, displaying, in the first user interface, a first selectable option that is selectable to display a representation of the second version of the second content item;
while displaying the first user interface including the first selectable option, receiving, via the one or more input devices, a first input corresponding to a selection of the first selectable option; and
in response to receiving the first input, displaying, via the display generation component, a representation of the second version of the second content item.

17. A non-transitory computer readable storage medium storing one or more programs, the one or more programs comprising instructions, which when executed by one or more processors of an electronic device, cause the electronic device to perform a method comprising:
displaying, via a display generation component, a first user interface of a first application configured to display a plurality of first content items, including a representation of a first content item of the plurality of first content items that includes a second content item, wherein displaying the first user interface includes:
in accordance with a determination that the second content item satisfies one or more criteria, including a criterion that is satisfied when the electronic device has access to a first version of the second content item and a second version of the second content item, displaying, in the first user interface, a first selectable option that is selectable to display a representation of the second version of the second content item;
while displaying the first user interface including the first selectable option, receiving, via one or more input devices, a first input corresponding to a selection of the first selectable option; and
in response to receiving the first input, displaying, via the display generation component, a representation of the second version of the second content item.
